(19) United States
(12) Patent Application Publication
(10) Pub. No.: US 2025/0378508 A1
(43) Pub. Date: Dec. 11, 2025

(54) SYSTEMS AND METHODS FOR MANAGING OIL AND GAS PRODUCTION

(71) Applicant: ConocoPhillips Company, Houston, TX (US)

(72) Inventors: Maryam Shahini, Houston, TX (US); Yu Wang, Houston, TX (US); Sanjay G. Pethe, Houston, TX (US); Bo Hu, Houston, TX (US); Sarah Coffman, Houston, TX (US); Rafee Shaik, Houston, TX (US); Douglas Hakkarinen, Houston, TX (US); Preston Howard, Howard, TX (US); Marc A. Roeder, Houston, TX (US)

(21) Appl. No.: 19/235,086

(22) Filed: Jun. 11, 2025

Related U.S. Application Data
(60) Provisional application No. 63/658,513, filed on Jun. 11, 2024.

(51) Int. Cl. G06Q 50/02; G06N 5/022; G06Q 10/0631; G06Q 20/14

(52) U.S. Cl. CPC G06Q 50/02; G06N 5/022; G06Q 10/06315; G06Q 20/14

(57) ABSTRACT

Implementations claimed and described herein provide systems and methods for managing natural resource production. The systems and methods use a machine learning model to generate categorizations associated with communication data. The machine learning model is built from historical data.

### CROSS-REFERENCE TO RELATED APPLICATIONS

The present application claims priority to U.S. Provisional Application No. 63/658,513, entitled “SYSTEMS AND METHODS FOR MANAGING OIL AND GAS PRODUCTION” and filed on Jun. 11, 2024, which is specifically incorporated by reference in its entirety herein.

### FIELD

Aspects of the presently disclosed technology relate generally to managing natural resource production and more specifically to managing oil and gas production systems.

### BACKGROUND

Natural resource production systems procure a variety of products and services from a variety of sources, ranging from individual contractors to large corporations. Additionally, each of these sources use their own format when communicating with the systems. In large corporations, these communications result in a large amount of data. With such decentralization and disaggregation across different channels, ascertaining meaningful analytics for supply chain function, finances, assets, etc. is challenging. It is with these observations in mind, among others, that various aspects of the present disclosure were conceived and developed.

### SUMMARY

Implementations described and claimed herein address the foregoing problems by providing systems and methods for managing natural resource production. The implementations described and claimed herein allow for categorization of communication data using a machine learning model to allow for real time analysis of supply chain function, finances, assets, etc. based on received communication data.

In some implementations, a system for managing natural resource production can comprise: a processing system in communication with a computing device and one or more databases over a network, the computing device having one or more input systems and one or more output systems, the processing system configured to receive communication data associated with at least one of a product or a service; a natural language processing system configured to process the communication data and generate embedding data; and a categorization system having a machine learning model, the categorization system configured to generate a categorization for the communication data using the machine learning model, the embedding data configured to be input into the machine learning model, the machine learning model built from historical communication data.

In some implementations, a method for managing natural resource production can comprise: receiving communication data associated with at least one of a product or a service, receiving historical communication data from one or more databases, processing the communication data using a natural language processing system, generating embedding data for the communication data using the natural language processing system, and generating a categorization for the communication data based on the embedding data using the machine learning model, the machine learning model built using the historical communication data.

In some implementations, a method can comprise: receiving historical communication data associated with at least one of a product or a service, processing the historical communication data using a natural language processing system, determining if the historical communication data requires re-embedding, generate embedding data for the historical communication data using the natural language processing system, identifying the historical communication data that requires a manual categorization, and training the machine learning model using the embedding data and the manual categorization.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example communication system.

FIG. 2 illustrates an example processing system.

FIG. 3 illustrates an example computing system that may implement various aspects of the communication system.

FIG. 4 illustrates example operations for training a machine learning model.

FIG. 5 illustrates example operations for managing natural resource production.

FIG. 6 illustrates example operations for validating the machine learning model.

FIG. 7 illustrates an example deep learning architecture.

FIG. 8 illustrates results using an example machine learning model.

FIG. 9 illustrates results using an example machine learning model.

FIG. 10 illustrates example model drift.

### DETAILED DESCRIPTION

Aspects of the present disclosure involve systems and methods to process communication data. The systems and methods described herein use a machine learning model to provide a robust categorization of the communication data for later analysis of supply function, finance, etc. The machine learning model is trained using historical data relating to categorization of communication data. This results in a more efficient platform that provides accurate global categorization for received communication data in the oil and gas industry. Additional advantages of the presently disclosed technology will become apparent from the detailed description below.

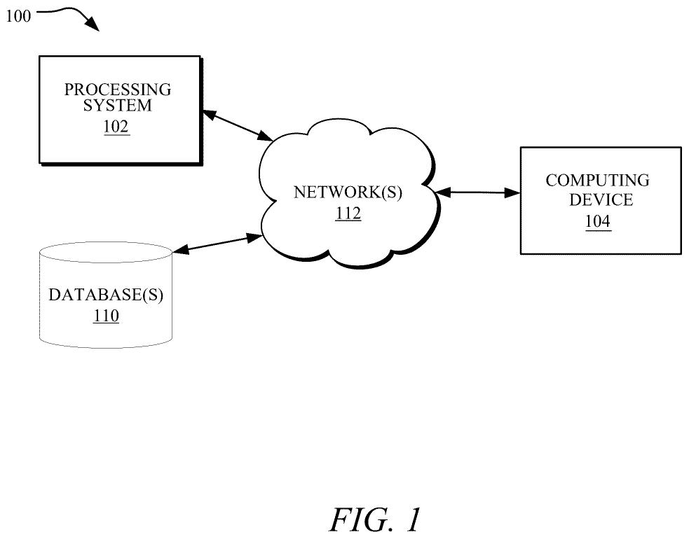

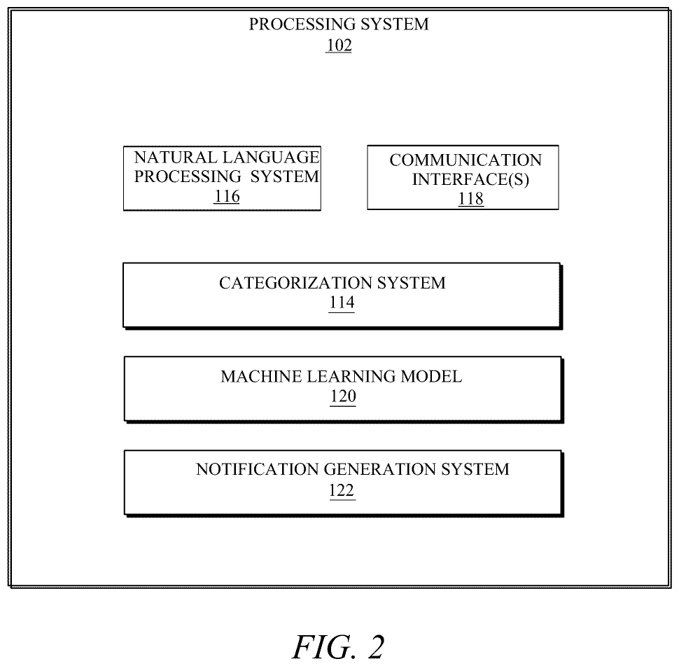

To begin a detailed description of an example system 100 for managing natural resource production. In an implementation, the system 100 processes communication data, such as, for example, a payment request, an invoice, bill, tab, and/or other commercial document issued by a seller to a buyer relating to a sale transaction of for a product and/or service and categorizing the communication data using a machine learning model, reference is made to FIGS. 1-10. The system 100 can include a processing system 102 configured to receive communication data for a product and/or service. The communication data can be received from a plurality of vendors and/or suppliers. The system 100 is configured to receive inputs by an operator via one or more input systems using, for example, a computing device 104 to input text, audio, and/or interact with an interactive user interface displayed on one or more output systems of, for example, the computing device 104. In an implementation, historical communication data is received one or more databases 110. The processing system 102, the computing device 104, and the one or more databases 110 are configured to interact with one another via a network(s) 112. As illustrated in greater detail below, any and/or all of the processing system 102, the computing device 104, and the one or more databases 110 may, in some instances, be special-purpose computing devices configured to perform specific functions.

The processing system 102 includes one or more computing devices (e.g., servers, routers, user interface devices, internet telephony computing device, and the like) that store and/or retrieve data in the one or more databases 110, generate user interfaces, execute a categorization system 114, a natural language processing system 116, a notification generation system 122, etc. by processing instructions. The processing system 102 may include a communication interface(s) 118 that is able to communicate with the one or more input systems and one or more output systems via the network(s) 112. For instance, the communication interface(s) 118 may be a network interface configured to support communication between the processing system 102 and the network(s) 112. The one or more input systems and one or more output systems may be part of the computing device 104 or separate from the computing device 104. The processing system 102 can be configured to train and maintain a machine learning model 120 to execute the techniques, as discussed in greater detail below. The processing system 102 can be configured to monitor and store (e.g., with appropriate permissions) communication from a vendor for further analysis and/or training of the machine learning model 120. In an implementation, the processing system 102 is configured to transmit the communication to another computing device or database, such as the one or more databases 110. In an implementation, the processing system 102 is associated with an organization or entity.

In an implementation, the computing device 104 includes one or more input systems and one or more output systems. For instance, the operator is able to input data to the processing system 102 via one or more interactive user interfaces using the computing device 104. The computing device 104 can be a smartphone, a tablet, a desktop computer, a laptop computer, or other personal computing device that may be used by an individual (e.g., the operator) to receive notification(s) and enter data. In some instances, the computing device 104 may be used to display notifications and/or other alerts using graphical user interfaces.

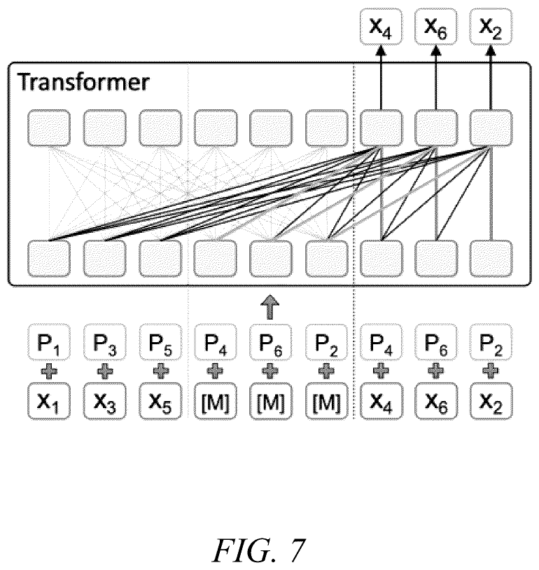

In an implementation, the processing system 102 includes instructions that direct and/or cause the natural language processing system 116 to execute processing techniques on the communication data to generate input columns and embedding data that is input into the machine learning model 120. In an implementation, the natural language processing system 116 uses a deep learning architecture, such as, for example, the transformer illustrated in FIG. 7.

In an implementation, the input columns include one or more of a basin asset, best material description, contract name, revised business unit, electronic serial number, item description, purchase order item description, purchasing organization name, unit of measure, user service, company name, vendor name, etc.

In an implementation, the machine learning model 120 is trained to generate a categorization for the communication data received from vendors related to provided products and/or services. The categorization is based on the embedding data. The machine learning model 120 may be built from historical communication data that has been previously categorized and stored, for example, at the one or more databases 110. In this implementation, the machine learning model 120 leverages historical communication data to generate the categorization of the received communication data. For instance, the training set can include historical communication data that resulted in an accurate categorization of the communication data.

In an implementation, the machine learning model 120 allows the categorization system 114 to categorize received communication data based on the input columns with the embedding data and the historical communication data. The historical communication data can be received from one or more of the one or more databases 110. In an implementation, the historical communication data includes accurately categorized communication data. In an implementation, the categories include one or more of an activity category, an element category, and a contract category. The activity category indicates what the objective is of the communication data. Examples of the activity category can include stimulation, drilling, maintenance, etc. The element category indicates what specific good and/or service is being purchased. Examples of the element category includes diesel, labor, maintenance, repair and operations (MRO) items, etc. The contract category indicates how the communication data relates to a contract or structure. Accordingly, the machine learning model 120 allows the categorization system 114 to generate categorization of communication data in real-time to allow for analysis of price changes, contract strategy, sourcing strategy, vendor management, budget management, and/or cost investigations using a large volume of data, despite the presence of missing and/or imbalanced data.

In an implementation, the notification generation system 122 is configured to perform one or more of the functions described herein. For example, the notification generation system 122 may have instructions that direct and/or cause the notification generation system 122 to generate a notification regarding the communication data. For instance, the notification is audio, visual, and/or textual notification. In an implementation, the notification indicates that the one or more communication data have been categorized. In an implementation, the notification may be sent upon request and/or periodically to the computing device 104, such as, for example, e-mail, to indicate one or more communication data have been categorized. For instance, the notification may be sent, hourly, daily, weekly, monthly, etc. In another implementation, the notification indicates that one or more categorizations of the communication data require validation. In this implementation, the machine learning model 120 is updated based on user input with regards to the validation. In an implementation, the notification is presented via one or more interactive user interfaces generated by the notification generation system 122 and transmitted, via the communication interface(s) 118, to the computing device 104 for display by the output system of the computing device 104.

The processing system 102 may have instructions that direct and/or cause the processing system 102 to receive communication data via the communication interface(s) 118, receive historical communication data via the one or more databases 110, process communication data using the natural language processing system 116, generate embedding data using the natural language processing system 116, generate categorizations for the communication data based on the embedding data using the machine learning model 120, transmit the categorizations to the one or more databases 110 for storage therein, and generate a notification using the notification generation system.

In another implementation, the processing system 102 may have instructions that direct and/or cause the processing system 102 to receive historical communication data via the one or more databases 110, process the historical communication data using the natural language processing system 116, verify historical communication data embedding data, generate embedding data using the natural language processing system 116, train the machine learning model 120 using the embedding data, identify invoices for manual categorization, and implement the machine learning model 120 into production.

The network(s) 112 can be any combination of one or more of a cellular network such as a 3rd Generation Partnership Project (3GPP) network, a third generation (3G) network, a fourth generation (4G) network, a fifth generation (5G) network, a Long-Term Evolution (LTE), an LTE Advanced Network, a Global System for Mobile Communications (GSM) network, a Universal Mobile Telecommunications System (UMTS) network, and the like. Moreover, the network(s) 112 can include any type of network, such as the Internet, an intranet, a Virtual Private Network (VPN), a Voice over Internet Protocol (VOIP) network, a wireless network (e.g., Bluetooth), a cellular network, a satellite network, combinations thereof, etc. The network(s) 112 can include communications network components such as, but not limited to gateways routers, servers, and registrars, which enable communication across the network(s) 112. In one implementation, the communications network components include multiple ingress/egress routers, which may have one or more ports, in communication with the network(s) 112.

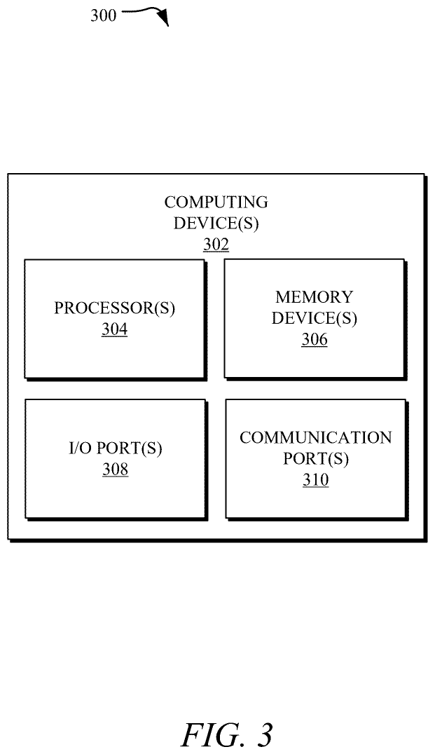

Turning to FIG. 3, a system 300 to process communication data can include one or more computing devices 302 for performing the techniques discussed herein. In one implementation, the one or more computing devices 302 include the computing device 104 and/or one or more servers of the processing system 102 to generate and execute the categorization system 114, the natural language processing system 116, notification generation system 122, etc. as a software application and/or a module or algorithmic component of software.

In some instances, the computing device 302 can include a computer, a personal computer, a desktop computer, a laptop computer, a terminal, a workstation, a server device, a cellular or mobile phone, a mobile device, a smart mobile device a tablet, a wearable device (e.g., a smart watch, smart glasses, a smart epidermal device, etc.) a multimedia console, a television, an Internet-of-Things (IoT) device, a smart home device, a medical device, a virtual reality (VR) or augmented reality (AR) device, a vehicle (e.g., a smart bicycle, an automobile computer, etc.), and/or the like. The computing device 302 may be integrated with, form a part of, or otherwise be associated with the systems 100-300. It will be appreciated that specific implementations of these devices may be of differing possible specific computing architectures not all of which are specifically discussed herein but will be understood by those of ordinary skill in the art.

The computing device 302 may be a computing system capable of executing a computer program product to execute a computer process. Data and program files may be input to the computing device 302, which reads the files and executes the programs therein. Some of the elements of the computing device 302 include one or more processors 304, one or more memory devices 306, and/or one or more ports, such as input/output (IO) port(s) 308 and communication port(s) 310. Additionally, other elements that will be recognized by those skilled in the art may be included in the computing device 302 but are not explicitly depicted in FIG. 3 or discussed further herein. Various elements of the computing device 302 may communicate with one another by way of the communication port(s) 310 and/or one or more communication buses, point-to-point communication paths, or other communication means.

The processor 304 may include, for example, a central processing unit (CPU), a microprocessor, a microcontroller, a digital signal processor (DSP), and/or one or more internal levels of cache. There may be one or more processors 304, such that the processor 304 comprises a single central-processing unit, or a plurality of processing units capable of executing instructions and performing operations in parallel with each other, commonly referred to as a parallel processing environment.

The computing device 302 may be a conventional computer, a distributed computer, or any other type of computer, such as one or more external computers made available via a cloud computing architecture. The presently described technology is optionally implemented in software stored on the data storage device(s) such as the memory device(s) 306, and/or communicated via one or more of the I/O port(s) 308 and the communication port(s) 310, thereby transforming the computing device 302 in FIG. 3 to a special purpose machine for implementing the operations described herein. Moreover, the computing device 302, as implemented in the systems 100-300, receives various types of input data (e.g., the communication data) and transforms the input data through various stages of the data flow into new types of data files (e.g., embedding data and categorizations). Moreover, these new data files are transformed further into a notification relating to the categorizations and sent to the computing device 104 to provide information regarding the categorizations, which enables the computing device 302 to do something it could not do before—categorizing communication data using a machine learning model trained using historical data.

Additionally, the systems and operations disclosed herein represent an improvement to the technical field of machine learning processing. For instance, the processing system 102 can generate categorizations with vast amounts of data having missing and/or imbalanced data without human intervention. Moreover, data can be leveraged from different data sources with varying levels of abstraction to provide a highly efficient and effective categorizations of communication data. These techniques are rooted in technology and could not have existed prior to the advent of machine learning analytics.

The one or more memory device(s) 306 may include any non-volatile data storage device capable of storing data generated or employed within the computing device 302, such as computer executable instructions for performing a computer process, which may include instructions of both application programs and an operating system (OS) that manages the various components of the computing device 302. The memory device(s) 306 may include, without limitation, magnetic disk drives, optical disk drives, solid state drives (SSDs), flash drives, and the like. The memory device(s) 306 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory device(s) 306 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the memory device(s) 306 which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computing device 302 includes one or more ports, such as the I/O port(s) 308 and the communication port(s) 310, for communicating with other computing, network, or vehicle computing devices. It will be appreciated that the I/O port 308 and the communication port 310 may be combined or separate and that more or fewer ports may be included in the computing device 302.

The I/O port 308 may be connected to an I/O device, or other device, by which information is input to or output from the computing device 302. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing device 302 via the I/O port 308. Similarly, the output devices may convert electrical signals received from the computing device 302 via the I/O port 308 into signals that may be sensed as output by a human, such as sound, light, and/or touch. The input device may be an alphanumeric input device, including alphanumeric and other keys for communicating information and/or command selections to the processor 304 via the I/O port 308. The input device may be another type of user input device including, but not limited to direction and selection control devices, such as a mouse, a trackball, cursor direction keys, a joystick, and/or a wheel; one or more sensors, such as a camera, a microphone, a positional sensor, an orientation sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing device 302 via the I/O port 308. For example, an electrical signal generated within the computing device 302 may be converted to another type of signal, and/or vice-versa. In one implementation, the environment transducer devices sense characteristics or aspects of an environment local to or remote from the computing device 302, such as, light, sound, temperature, pressure, magnetic field, electric field, chemical properties, physical movement, orientation, acceleration, gravity, and/or the like.

In one implementation, the communication port 310 is connected to the network(s) 112 so the computing device 302 can receive network data useful in executing the methods and systems set out herein as well as transmitting information and network configuration changes determined thereby. Stated differently, the communication port 310 connects the computing device 302 to one or more communication interface devices configured to transmit and/or receive information between the computing device 302 and other devices by way of one or more wired or wireless communication networks or connections. Examples of such networks or connections include, without limitation, Universal Serial Bus (USB), Ethernet, Wi-Fi, Bluetooth®, Near Field Communication (NFC), and so on. One or more such communication interface devices may be utilized via the communication port 310 to communicate with one or more other machines, either directly over a point-to-point communication path, over a wide area network (WAN) (e.g., the Internet), over a local area network (LAN), over a cellular network (e.g., third generation (3G), fourth generation (4G), Long-Term Evolution (LTE), fifth generation (5G), etc.) or over another communication means. Further, the communication port 310 may communicate with an antenna or other link for electromagnetic signal transmission and/or reception.

In an example, the processing system 102, the categorization system 114, the natural language processing system 116, the notification generation system 122, etc., and/or other software, modules, services, and operations discussed herein may be embodied by instructions stored on the memory device(s) 306 and executed by the processor 304.

The system set forth in FIG. 3 is but one possible example of a computing device 302 or computer system that may be configured in accordance with aspects of the present disclosure. It will be appreciated that other non-transitory tangible computer-readable storage media storing computer-executable instructions for implementing the presently disclosed technology on a computing system may be utilized. In the present disclosure, the methods disclosed may be implemented as sets of instructions or software readable by the computing device 302.

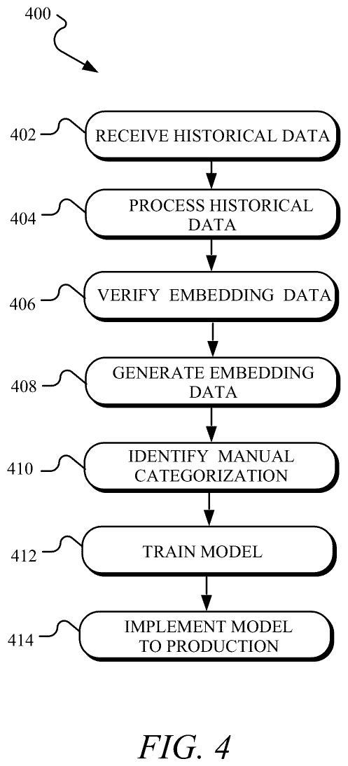

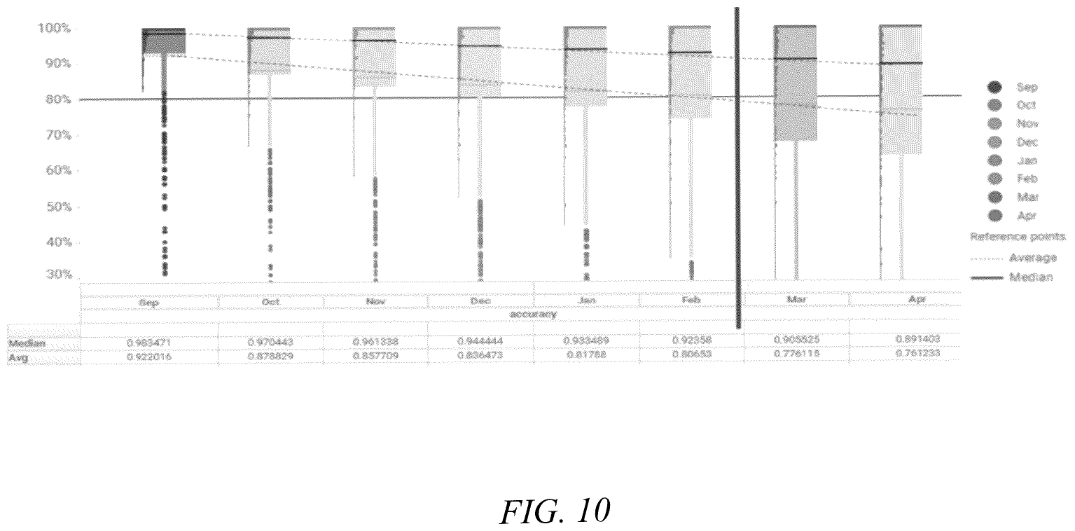

FIG. 4 depicts an example method 400 to train a machine learning model, which can be performed by any of the systems 100-300 discussed herein. The method 400 can, in some instances, occur in real time. In an implementation, method 400 is performed periodically to restrict model drift, as illustrated in FIG. 10. For instance, the method 400 can be performed daily, monthly, yearly, etc.

At operation 402, the method 400 can receive historical communication data via the communication interface(s) 118 from the database(s) 110. In an implementation, the communication data is inputted by a user via one or more input systems of the computing device 104.

At operation 404, the method 400 can process the historical communication data using the natural language processing system 116. In an implementation, the processing includes one or more of cleaning the historical communication data and generating one or more input columns. In an implementation, the one or more input columns include translated acronyms and combined column values.

At operation 406, the method 400 can verify embedding data. In an implementation, the embedding data is verified by comparing input columns to determine if changes exist that require re-embedding of the input columns.

At operation 408, the method 400 can generate embedding data using the natural language processing system 116. The embedding data is generated for the input columns that need re-embedding.

At operation 410, the method 400 can identify communication data that need manual categorization based on criteria. For instance, the criteria may be that no categories can be identified for the communication data. The manual categorization may be input by the operator using an interactive user interface displayed on the computing device.

At operation 412, the method 400 can train the machine learning model 120 using the embedding data and the manual categorization.

At operation 414, the method 400 can implement the machine learning model 120 into production and proceed to example method 500.

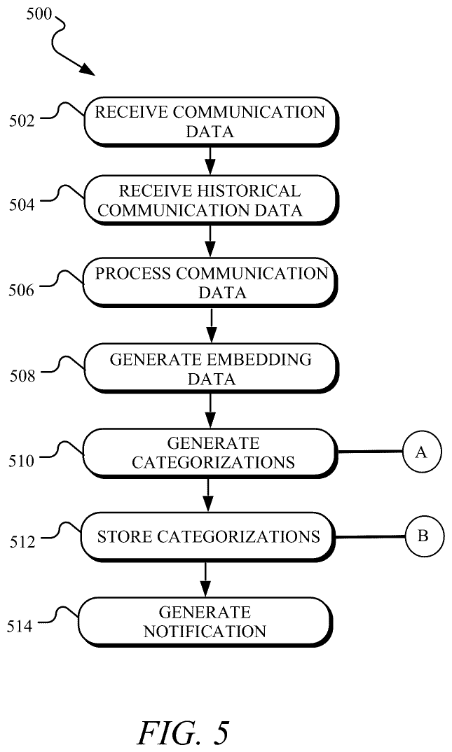

FIG. 5 depicts the example method 500 to manage natural resource production, which can be performed by any of the systems 100-300 discussed herein. The method 500 can, in some instances, occur in real time.

At operation 502, the method 500 can receive communication data via the communication interface(s) 118 from the computing device 104 and/or database(s) 110. In an implementation, the communication data is inputted by a user via one or more input systems of the computing device 104. In an implementation, the communication data is uploaded that has not been previously categorized.

At operation 504, the method 500 can receive historical communication data via the communication interface(s) 118 from the one or more databases 110.

At operation 506, the method 500 can process communication data using the natural language processing system 116. In an implementation, the processing includes one or more of cleaning the communication data and generating one or more input columns using the historical communication data. In an implementation, the one or more input columns include translated acronyms and combined column values.

At operation 508, the method 500 can generate embedding data using the natural language processing system 116. The embedding data is generated for the input columns.

At operation 510, the method 500 can generate categorizations for the communication data based on the embedding data using the machine learning model 120. After operation 510, the method may continue to operation 512 and/or proceed to example method 600 to validate the machine learning model.

At operation 512, the method 500 can cause the categorizations to be stored, such as, for example, in the one or more databases 110. In an implementation, the categorizations can be stored as historical data.

At operation 514, the method 500 can generate a notification using the notification generation system. In an implementation, the notification can be output via the computing device 104.

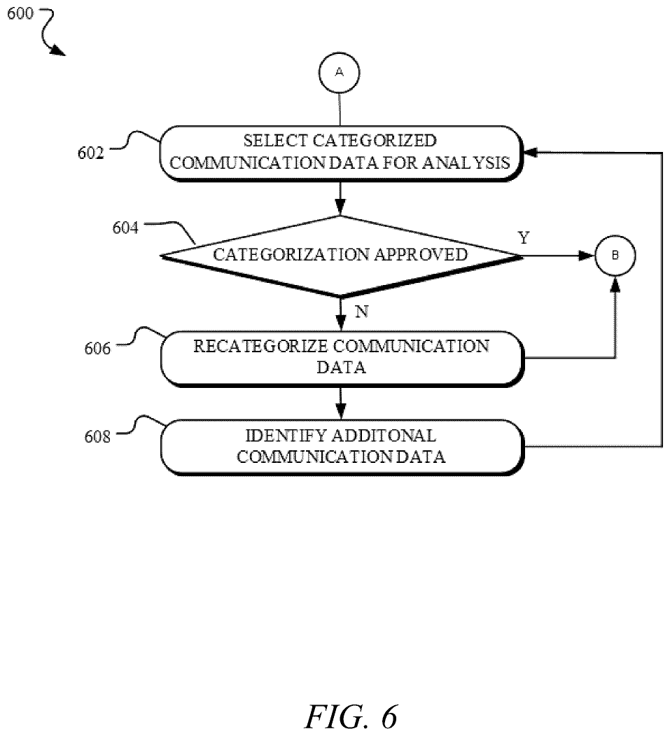

FIG. 6 depicts the example method 600 to validate the machine learning model, which can be performed by any of the systems 100-300 discussed herein. The method 600 can, in some instances, occur in real time.

At operation 602, the method 600 can select categorized communication data for analysis. In an implementation, categorized communication data with a prediction probability below a threshold is selected.

At operation 604, the method 600 can approve the categorization by comparing the categorization assigned to the communication data with an expected categorization. If the categorization is correct, the method 600 can proceed to operation 512 of the method 500 to cause the categorizations to be stored, such as, for example, in the one or more databases 110 as historical communication data. If the categorization is incorrect, the method can proceed to operation 606.

At operation 606, the method 600 can recategorize the communication data by analyzing the communication data. The method 600 can proceed to operation 512 of the method 500 to cause the recategorizations to be stored, such as, for example, in the one or more databases 110 as historical data. In an implementation, the recategorization is based on a user input at one or more user interfaces.

At operation 608, the method 600 can identify additional communication data for review. The addition communication data is identified based on similarity with the recategorized communication data. The method 600 can proceed to operation 602 for review of the additional communication data.

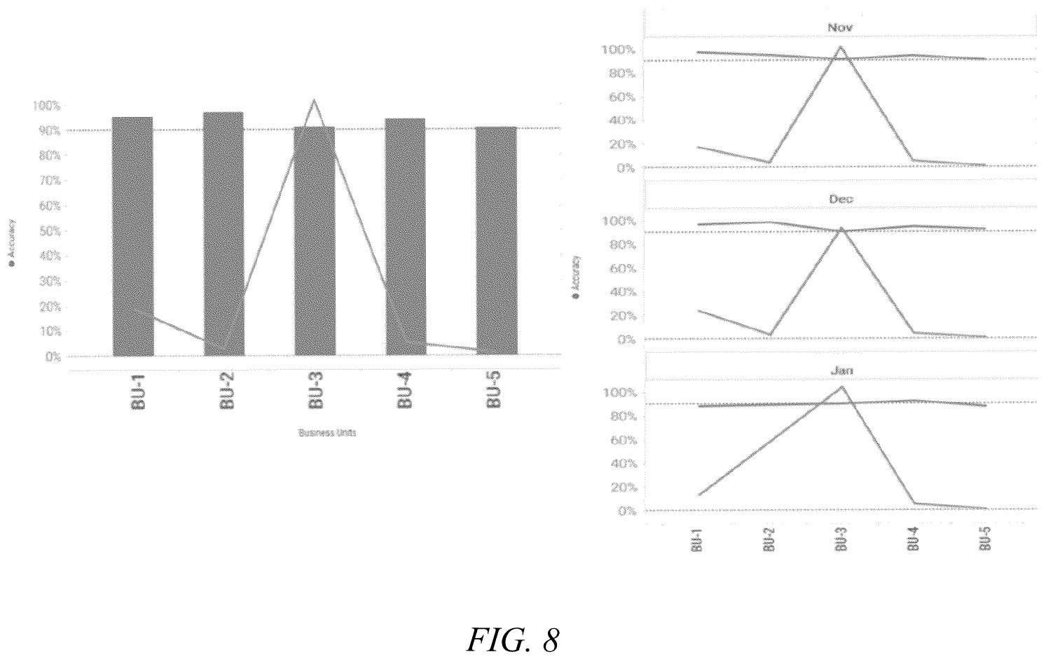

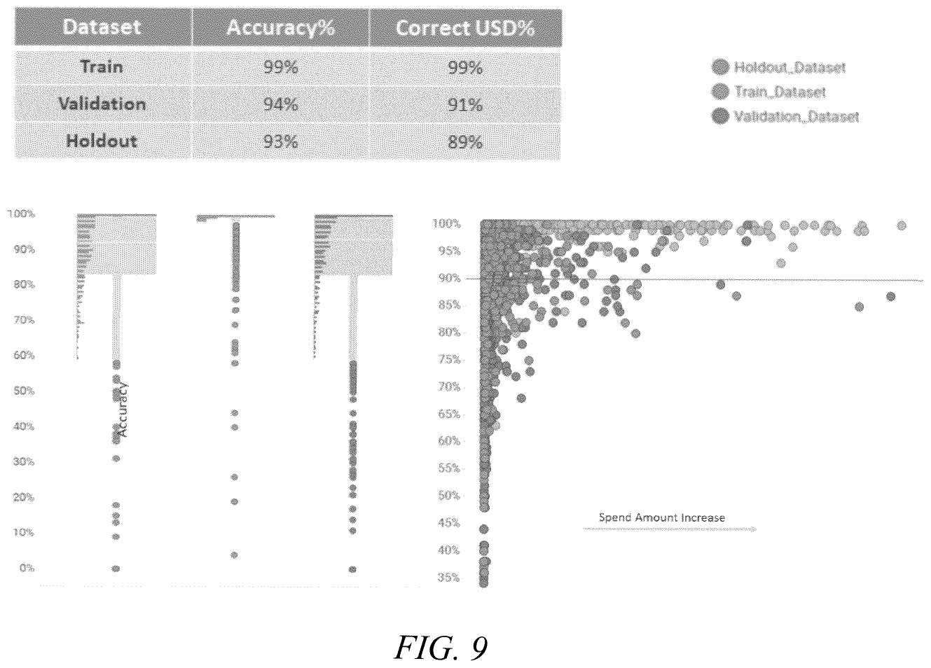

Performance of the machine learning model 120 trained to categorize communication data in accordance with the disclosure herein was found to accurately categorize a large number of communication data as illustrated in FIGS. 8 and 9. The accuracy was found to exceed 85%.

It is to be understood that the specific order or hierarchy of operations in the methods depicted in FIGS. 4-6 and throughout this disclosure are instances of example approaches and can be rearranged while remaining within the disclosed subject matter. For instance, any of the operations depicted in FIGS. 4-6 may be omitted, repeated, performed in parallel, performed in a different order, and/or combined with any other of the operations depicted in FIGS. 4-6 or discussed herein.

Furthermore, any term of degree such as, but not limited to, “substantially,” as used in the description and the appended claims, should be understood to include an exact, or a similar, but not exact configuration. Similarly, the terms “about” or “approximately,” as used in the description and the appended claims, should be understood to include the recited values or a value that is three times greater or one third of the recited values. For example, about 3 mm includes all values from 1 mm to 9 mm, and approximately 50 degrees includes all values from 16.6 degrees to 150 degrees.

Lastly, the terms “or” and “and/or,” as used herein, are to be interpreted as inclusive or meaning any one or any combination. Therefore, “A, B, or C” or “A, B, and/or C” mean any of the following: “A,” “B,” or “C”; “A and B”; “A and C”; “B and C”; “A, B and C.” An exception to this definition will occur only when a combination of elements, functions, steps or acts are in some way inherently mutually exclusive.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A system for managing natural resource production comprising:
a processing system in communication with a computing device and one or more databases over a network, the computing device having one or more input systems and one or more output systems, the processing system configured to receive communication data associated with at least one of a product or a service;
a natural language processing system configured to process the communication data and generate embedding data; and
a categorization system having a machine learning model, the categorization system configured to generate a categorization for the communication data using the machine learning model, the embedding data configured to be input into the machine learning model, the machine learning model built from historical communication data.

2. The system of claim 1 further comprising:
a notification generation system configured to generate a notification associated with the categorization, the processing system configured to transmit the notification to the computing device to cause the notification to be presented using the one or more output systems.

3. The system of claim 2, wherein the notification includes an indication that the communication data has been categorized.

4. The system of claim 1, wherein the computing device includes at least one of a smartphone, a tablet, a desktop computer, a laptop computer, or a personal computing device.

5. The system of claim 1, wherein the natural language processing system is configured to process the communication data by generating one or more input columns.

6. The system of claim 5, wherein the one or more input columns include one or more translated acronyms and one or more combined column values.

7. The system of claim 1, wherein the communication data includes a payment request.

8. The system of claim 7, wherein the payment request is a commercial document issued by a seller to a buyer.

9. The system of claim 1, wherein the categorization includes at least one of an activity category, an element category, or a contract category.

10. The system of claim 9, wherein the activity category indicates an objective of the communication data, the element category indicates one or more of the product or the service being purchased, and the contract category indicates to one or more of a contract or a structure of the communication data.

11. A method for managing natural resource production comprising:
receiving communication data associated with at least one of a product or a service;
receiving historical communication data from one or more databases;
processing the communication data using a natural language processing system;
generating embedding data for the communication data using the natural language processing system; and
generating a categorization for the communication data based on the embedding data using a machine learning model, the machine learning model built using the historical communication data.

12. The method of claim 11, wherein the communication data is inputted via one or more input systems of a computing device.

13. The method of claim 11, further comprising:
generating a notification associated with the categorization; and
causing the notification to be presented using one or more output systems.

14. The method of claim 11, wherein the processing includes generating one or more input columns, the one or more input columns including at least one of a translated acronym or a combined column value.

15. The method of claim 11, further comprising:
generating instructions to cause the categorization to be stored in the one or more databases.

16. The method of claim 11, wherein the communication data includes a payment request.

17. The method of claim 11, wherein the categorization includes at least one of an activity category, an element category, or a contract category.

18. The method of claim 17, wherein the activity category indicates an objective of the communication data, the element category indicates one or more of the product or the service being purchased, and the contract category indicates to one or more of a contract or a structure of the communication data.

19. A method comprising:
receiving historical communication data associated with at least one of a product or a service;
processing the historical communication data using a natural language processing system;
determining if the historical communication data requires re-embedding;
generate embedding data for the historical communication data using the natural language processing system;
identifying the historical communication data that requires a manual categorization; and
training a machine learning model using the embedding data and the manual categorization.

20. The method of claim 19, further comprising:
implementing the machine learning model into production.
